(19) United States
(12) Patent Application Publication
(10) Pub. No.: US 2008/0307627 A1
(43) Pub. Date: Dec. 18, 2008

(54) Plug and system for inserting the same into a substrate

(76) Inventor: Paul Gertner, Brooklyn, NY (US)

Correspondence Address: Allen R. Kipnes, Esquire;WATOV & KIPNES, P. C., P. O. Box 247, Princton Junction, NJ, 08550, US

(21) Appl. No.: 12/228,906

(22) Filed: Aug. 18, 2008

Related U.S. Application Data
(63) Continuation-in-part of application No. 11/367,887, filed on Mar. 3, 2006.
(60) Provisional application No. 60/710,387, filed on Aug. 23, 2005.

(51) Int. Cl. B23Q 17/00; B23P 21/00

(52) U.S. Cl. 29/407.1; 29/705

(57) ABSTRACT

A system for precisely matching an insert to a predrilled hole and a plug to a plug hole within a designated substrate including a predrill assembly having a first set of parameters, an insert having a second set of parameters precisely matched to the first set of parameters for the designated substrate, and a plug having a third set of parameters precisely matched to the first set of parameters for the designated substrate.

### RELATED APPLICATION

The present application is a Continuation-in-Part application of U.S. Nonprovisional patent application Ser. No. 11/367,887, filed Mar. 3, 2006, which claims priority benefits of U.S. Provisional Patent Application No. 60/710,387 filed Aug. 23, 2005.

### FIELD OF THE INVENTION

The present invention is generally directed to a system for protecting inserts seated within a predrilled hole. Included in the system is a plug insertable into a portion of a substrate to cover and conceal the corresponding insert seated within the predrilled hole.

### BACKGROUND OF THE INVENTION

There are numerous instances in which an insert such as a screw must be used to attach two portions of a substrate together (e.g. a top substrate portion and a bottom substrate portion). Quite often, a hole must be drilled into the substrate (often referred to as “predrilling”) so that the insert can be effectively inserted therein. A plug hole is also produced during the course of the predrilling, which is disposed above the hole to accommodate a plug. In this manner, the plug conceals the insert for a more pleasing and aesthetic appearance and also to provide protection for the insert. As used herein a tool for conducting a predrilling operation is referred to as a predrill or predrill assembly and the hole, which is thereby formed is referred to as a predrilled hole.

Predrilling can be particularly complicated when preparing a predrilled hole for an insert such as a screw with a countersink head style. Countersink head styles are common for wood screws, but can be used for a number of applications where all or part of the screw head is sunk below the surface of the top substrate portion. Where a countersink is required the predrilled hole must be correctly matched dimension-wise not only to the shank portion of the screw, but also to the screw head and the plug. Up until now there has been no unified system for correctly matching predrill assemblies, inserts and plugs for a designated substrate to provide an optimum fit of the insert within the predrilled hole and the plug within the plug hole of the designated substrate.

The current invention systematizes the matching of the predrill assembly, insert and plug for the designated substrate by recognizing that where predrilling is required, the predrill assembly, the insert, and the plug for a given application requiring a designated substrate should be viewed together as a fastening system. The plug is used to conceal the insert as will be further discussed hereinafter. In prior art systems, the installer typically selects an insert for a certain application and then attempts to find a tool or combination of tools that can create a workable hole, frequently requiring guesswork and/or trial and error and typically less than an optimum match between the insert and the predrilled hole and the plug and the plug hole, respectively.

One example where predrilling and countersink style screws are often required is in the fabrication of decks in which the substrate is, for example, a decking material, typically a hardwood or a composite material (e.g. plastic wood composite). Many portions of the decking material are connected together by decking screws in which the decking material is predrilled to form predrilled holes therein which are adapted to receive a decking screw (typically a countersink decking screw). Predrilling is often performed when the substrate is sufficiently hard so that the direct insertion of the screw into the undrilled substrate is problematic and difficult to achieve without damaging the screw and/or the substrate.

Typically, the deck fabricator will start by selecting an insert that will meet various functional requirements of the finished project. In making this selection, the fabricator will also determine whether predrilling is necessary. In the event that predrilling is needed, the fabricator then attempts to find a predrill assembly capable of forming a predrilled hole with the dimensions needed to correctly install the selected insert. It is desirable to have the predrill assembly form a predrilled hole, which is precisely matched to the screw so that the best possible fit can be obtained. The same process is implemented during the course of the predrilling to produce a plug hole that matches the corresponding plug.

As used herein the term “precisely matched” shall mean that the predrill assembly, insert and plug are shaped and dimensioned in a manner which takes into account the type of substrate, such that when the insert is operatively placed in the predrilled hole, there is no damage to the predrilled hole or insert and the insert achieves a desired position within the predrilled hole, and that the insert can achieve maximum fastening performance while seated in the predrilled hole. “Operatively placed” means that the plug can be inserted snugly but fairly easily into the hole by use of a rubber mallet or similar tool that will not cause damage to either the plug or substrate. Furthermore, the plug can be inserted with zero to minimal need for surface finishing. An example of minimal finishing would be minor sanding.

However, if the insert and plug selected for insertion into the substrate and the predrill assembly, are not precisely matched various problems may arise. In general terms, if the required predrilled hole is too large, the function of the insert and plug can be compromised. As an example, the insert may not hold down the decking material over the life of the installation (i.e. failure to achieve maximum functional performance). If the required predrilled hole is too small, the insert may break during insertion (i.e. damage to the insert), forcing the insert may cause the workpiece to split or otherwise be damaged, or it may not be possible to fully insert the screw resulting in the head protruding from the substrate surface (i.e. failure to achieve a desired position within the predrilled hole). Likewise, if the predrilled hole for the plug is too small in diameter, the plug will not fit. If it is too small in depth, the inserted plug will require more time-consuming re-work, such as sawing off the top excess before sanding. If the hole is too large in diameter, the inserted plug can be unsightly, and water can penetrate into the hole, a problem in outdoor applications. If the hole is too deep, the plug can migrate below the surface of the work piece, creating an unsightly depression where water can accumulate.

Inserts such as screws or other fasteners are used to attach one or more substrate portions or work pieces together. There are a large variety of insert configurations that have been developed for specific applications. For example, there are screws particularly adapted for attaching metal to metal, metal to wood, wood to metal, wood to wood, etc. There are screws for interior applications and exterior applications. Besides the choice of material, variables affecting the construction of screws, include length, diameter, and head design. Despite these variables for any given application, the choices are fairly limited and generally well-known to skilled craftsmen. Thus, while there are many possible types of inserts, there are many applications where most of the installation requires only a small range of insert styles and designs. In particular, this is often the case for cabinetry and deck construction. Thus, a systematic and precise matching of inserts with predrill assemblies is highly useful and practical for many construction and assembly projects.

There are many instances where predrilling is required in order to properly fasten substrate portions or work pieces together. One such example is the insertion of a particular stainless steel screw (which is a relatively soft material) into a very hardwood, such as mahogany or ipe. For instance, stainless steel may be required in a particular installation for the corrosion resistance it affords. In this instance, the installer selects the appropriate insert and then attempts to identify the predrill assembly that provides the closest match for the insert so that the insert can be properly placed within the predrilled hole. There are instances where the installer has the option of considering various inserts, which may or may not require predrilling, and then decide whether predrilling is needed.

In these examples, predrilling frequently results in a better installation, either by permitting the use of a superior insert or achieving better results in the installation. By making predrilling easier, the current invention makes it more feasible for installers to select more desirable fasteners than might otherwise be available for the particular application. Considerations that are characteristic of the selection of a suitable insert for a particular fastening application include:

1. Stainless steel inserts are generally softer than hardened carbon steel. Generally, stainless steel offers superior corrosion resistance compared to carbon steel inserts that have been coated to withstand corrosion. Since stainless steel inserts are made of a softer material, they are more likely to require predrilling.

2. Hardwoods, such as mahogany and ipe, are more likely to require predrilling than softer woods such as yellow pine. Thus, the use of hardwoods, which are generally recognized as a superior product, must be weighed against the effort required to predrill.

3. Wood/plastic composite materials often require predrilling in order to clear the waste material from the predrilled hole. If an attempt was made to place an insert into a substrate of this type without predrilling, unsightly mushrooming of the waste material on the surface around the insert head can result.

4. Thinner gauge inserts are not as strong as heavier gauge inserts, and are therefore more likely to require predrilling. Thinner inserts can be advantageous where it is desirable to minimize the visibility of the insert head surface.

Thus, precisely matching the predrill assembly (e.g. predrill bit) to the insert depends on the insert that will be used and the intended application. The strength of the insert is a first consideration. The ability of any insert to withstand torsional resistance depends on the material and the insert design. The insert material can vary according to hardness. For instance, No. 305 stainless steel (a common grade used in inserts) is unhardened and will not allow the same degree of torque as a hardened steel insert of the same exact dimensions and design. In addition, the design of the insert can itself affect the amount of torque required to drive the insert into the substrate. The diameter or depth of the required predrilled hole may vary according to the strength of the insert. For example, square shaped threads (as opposed to traditional helical threads) present a serrated cutting edge which reduces the required driving torque and can reduce the amount of predrilling required with respect to depth and/or diameter.

A second consideration is the nature of the substrate material. If the substrate material is sufficiently soft, predrilling may not be necessary, subject to the strength of the insert (itself dependent on the insert material, design and dimensions). If predrilling is needed, the depth and diameter of the necessary predrilled hole will be a factor in determining the correctly matched predrilling tool. For instance, if both substrate portions are made of hardwood, then the predrilled hole may need to be the full length of the insert. In many instances where hardwoods are used, they are mounted onto less expensive softwoods. In this event, the depth of the predrilled hold may only have to match the thickness of the hardwood portion of the substrate as the insert can penetrate the softwood portion without predrilling. An aspect of the present invention therefore not only accounts for the structural characteristics of the insert and predrill assembly but also the substrate material to arrive at a precise match.

A third consideration is the diameter of the predrilled hole and plug hole. There is a generally accepted rule in woodworking that predrilled holes and corresponding diameters of the predrill assembly (e.g. predrill bit) should be sized to correspond to the minor diameter of the shank portion of the insert. The minor diameter is measured inside the flutes of the threaded portion of an insert. There are instances for very hard woods in which the predrilled holes are selected somewhat larger than the minor insert diameter. This is especially apparent when very hard woods are used as the substrate. The basic goal is to make the smallest predrilled hole possible, without instigating failure. In all cases the predrill bit diameter must not exceed the major diameter of the insert or the insert will not hold in place. The major diameter is measured from the outside edges of the insert threads.

The diameter of the unthreaded portion of the insert is a further consideration of the insert diameter. Wood screws have unthreaded portions intended to correspond to the width of the surface substrate material. The threaded portion engages only the underlying substrate. The unthreaded shank portion generally has a diameter between the major and minor diameters. When the predrilled hole depth is limited to the top portion of the substrate, the predrilled hole diameter can be sized to the unthreaded diameter, depending on the stability of the substrate material, the insert head diameter and the ability of the threaded portion to cut through the top portion of the substrate.

A fourth consideration is the insert head design, where the insert head is countersunk into the substrate. There are two variables affecting the countersink portion of a predrilled hole: The width of the predrilled hole and the angle of the insert head, measured from the plane of the underside of the insert head. The width of the predrilled hole should be slightly larger than the diameter of the insert head. The angle of the countersink portion of the predrilled hole needs to be matched to the angle of the insert head.

A fifth consideration should be the diameter of the plug. The plug diameter should match the width of the predrilled hole.

A sixth consideration is the depth of the countersink hole and plug hole, often regulated by a stop collar. Stop collars cause the depth of the predrilled hole to be terminated. Depending on the application, it may be desirable for the final countersink insert head to be flush to the surface of the substrate, slightly below the surface or significantly below the surface. For instance, sometimes the insert head is countersunk well below the surface, in order to produce a plug hole, thus leaving room for a plug (e.g., wood plug) to be inserted, to hide the head of the insert. In these instances, the plug needs to be designed or chosen so that its depth (vertical measure when inserted) matches the depth of the hole as measured from the top of the insert (screw head) to the top of the work piece. Matching may be either precise or leaving a slight excess on top of the work piece for elimination by minor sanding.

Depending on the nature of the substrate, a stop collar may mar or burnish the surface of the substrate surface. This negative effect can be overcome by providing a free-spinning stop collar and by the use of a contact surface made of rubber or other soft material where the stop collar contacts the substrate. Here again, the precise matching of the predrill assembly and insert takes into account the characteristics of the substrate.

A seventh consideration is the material used for the predrill assembly. Predrill assemblies (e.g. predrill bit) can be made of various materials. Such materials can vary according to how long they maintain sharpness, with longer-lasting materials costing more. Typically, and as an example, cobalt steel costs more and lasts longer than high speed steel. Generally, the longer a predrill bit maintains its edges, the less heat that is generated, and the longer the predrill assembly will last.

The nature of the waste material generated during predrilling is a further consideration. The waste material from the predrilled hole is brought up into the countersink area by the auger motion of the flutes of the predrill assembly. This material can accumulate at the countersink, impeding the countersink and other portions of the predrill assembly including a stop collar if present. The waste material can vary from a fine dust to an aggregated web, the latter requiring a large area to allow the waste to accumulate.

When considering all of the foregoing, it is not surprising that when one selects a predrill assembly for predrilling holes into a substrate, there is typically less than a perfect match when selecting inserts (e.g. screws) and plugs which must enter the predrilled hole and the plug hole, respectively, to fasten the respective portions of a designated substrate. Most commonly, installers who face this problem piece together countersink predrill components for forming a predrilled hole from various assortments on the market, sometimes sold as kits, typically without taking into account all of the variables associated with the substrate material.

Generally there are three types of components: predrill bits, countersink predrill bits, and stop collars. Installers need to carefully examine the insert and the plug they plan to use and try to find the three components that best match their insert and plug characteristics including dimensions and the optimum predrilled hole size for their particular installation. Then the installer needs to assemble the components, usually involving the use of set-screws, in order to achieve the desired predrilled hole and countersink depth. This often requires trial and error to achieve the correct depth, particularly for the countersink depth.

Furthermore, given the complexities of the selection process, installers may not have sufficient technical information, regarding such things as the hardness and other characteristics of the substrate and the torsional strength of the insert, or the precise dimensions of the insert and plug to make the best decision. As an example of the latter, the minor diameter of the insert is often an important variable in selecting a predrill assembly, but this information is rarely available to installers, and not measurable without laboratory instrumentation. Informed installers may resort to holding an insert up to the light, side by side with possible predrill assemblies, to assist in the selection process, which is an obviously imprecise method of selection. Finally, when using the commonly available self-assembly kits, the set screws frequently come loose, and the set-up process must often be repeated, and then repeated again when a component fails and the set-up regimen must be repeated.

Failure to provide a perfect fit between an insert and a predrilled hole, and a plug and a plug hole, can result in significant disadvantages. If there is an improper fit such that the insert is smaller than desired for the predrilled hole, a gap can develop between the insert and the boundary of the predrilled hole which can result in the insert and/or insert head not holding within the substrate. In addition, a gap can develop between the insert and the boundary of the predrilled hole which can allow water or other materials to enter into the predrilled hole resulting in corrosion of the insert and degradation of the predrilled hole. In addition, a mismatch between the insert and the predrilled hole is unsightly and detracts from the appearance of the construction.

If the predrilled hole is smaller than the selected insert, the insert can break when inserted or the insert head may protrude from the surface of the substrate, which results in various safety and performance problems. Depending on the application, it may be desirable for the final countersink insert head to be flush to the surface of the substrate, slightly below the surface or significantly below the surface. For instance, sometimes the insert head is countersunk well below the surface, in order to leave room for a wood plug to be inserted, to hide the head of the insert.

The plug is typically composed of a deformable material such as wood or plastic, and used to tightly seal and cover the insert head within the plug hole of the substrate or otherwise fill or conceal the plug hole and the insert seated in the predrilled hole. Most commonly the plug is made from the same material (e.g., type of substrate, color of substrate, etc.) as the workpiece in order to blend in and be less visible against the workpiece surface, as well as function better due to compatibility of physical characteristics. The plug may be glued or press-fitted into the plug hole in order to cover the insert head. The plug is generally inserted so that it extends at least flush with the surface of the substrate. Any portion of the plug that extends above the surface of the substrate is cut off and smoothed or sanded down in a suitable manner.

The plugs are typically fabricated either from dowels, or from wood boards through the use of specialized tools called plug cutters. The resulting plugs are generally cylindrical in shape with straight sides. Cylindrical plugs often suffer from several shortcomings. Cylindrical plugs typically must be made slightly smaller than the plug hole being filled to facilitate insertion. This size difference produces a small noticeable space between the plug and the walls of the plug hole, which may result in a poor fit, dislodgement of the plug, unsightly gaps, gaps where water can enter, and/or leakage of adhesive.

An alternative to cylindrical plugs with straight walls, is a plug with flared walls. Flared plugs generally have bottom diameters smaller than the plug hole, and top diameters that are greater. They are generally pushed in as far as they can go, and then sawed or chiseled off on top. Cylindrical plugs used in conjunction with the current invention are superior to flared plugs for two reasons. Cylindrical plugs require much less or no re-working. Secondly, flared plugs exhibit a tendency to migrate up and over the top of the work piece surface as the work piece expands and contracts over time.

Accordingly, there is a need to provide a plug and a system for inserting the same into a plug hole within a substrate in combination with an insert seated within a predrilled hole that at least reduces or avoids the problems discussed above. In particular, there is a need for a plug and a system for inserting the same into a plug hole within a substrate in combination with an insert seated within a predrilled hole that is designed to maximize surface contact between the plug and plug hole for secure retainment therein, enhance resistance against dislodgement over time, and sufficiently accommodate an optional adhesive to minimize leakage and stresses due to thermal changes. There is a further need for a system for inserting a plug into a plug hole within substrate, which provides a plug that substantially matches the corresponding plug hole produced by a predrill assembly in the substrate in combination with an insert seated within a predrilled hole.

### SUMMARY OF THE INVENTION

The present invention is generally directed to a system and method for providing the precise selection and utilization of an insert and plug for a particular substrate in which the system includes a predrilling assembly, an insert precisely matched as defined herein to achieve a desirable fitting of the insert in the predrilled hole formed by the predrill assembly to enable a desirable fastening of two substrates portions together, and a plug precisely matched as defined herein (zero to minimal need for surface finishing) to achieve a desirable fitting of the plug in the plug hole formed by the predrill assembly to effectively conceal the insert seated within the predrilled hole. The system and method of the present invention may be utilized for carpentry tasks including, for example, furniture making, cabinetry and flooring. The term “plug” refers to a piece of deformable material such as wood for tightly sealing a recess or plug hole provided in the substrate. A plug will typically comprise at least a substantially cylindrical piece of deformable material. Examples of suitable plugs include straight-walled plugs and plugs having a lower end chamfered portion (as shown, for example, in FIG. 6).

The system of precisely matching the predrill assembly, the insert and the plug takes into account the dimensions of each component, the materials used to construct the components and the type of substrate including the substrate material, its hardness and dimensions. The predrill assembly, the inserts and the plugs may be sold as a kit or may be sold separately with information provided as part of the system enabling the user to precisely match the predrill assembly, the insert and the plug for a designated substrate to achieve the objects of the invention.

In one aspect of the invention, the predrill assembly is the type disclosed in U.S. Pat. No. 7,258,513, which covers a device for precisely incorporating a predrilled hole into a substrate which includes a depth limiting device having a stop collar, a spindle and means operatively associated with the stop collar and the spindle for isolating the rotation of the spindle from the stop collar. Although this is a preferred form of the predrill assembly, it will be understood that the predrill assembly may only include a predrill bit which has been precisely matched with inserts to be inserted within the predrilled hole and plugs to be inserted within the plug hole above the predrilled hole.

In particular, there is provided a plug and a system for inserting the same into a substrate in combination with an insert. The present invention further provides a method for providing the precise selection and utilization of the insert and the plug for a particular substrate in which the system includes a predrilling assembly, an insert precisely matched as defined herein to achieve a desirable fitting of the insert in the predrilled hole formed by the predrill assembly to enable a desirable fastening of two substrates portions together, and a plug precisely matched as defined herein to achieve a desirable fitting of the plug in the plug hole formed by the predrill assembly.

In one aspect of the present invention, there is provided a system for precisely matching a plug to a plug hole corresponding to a predrilled hole within a designated substrate comprising:

a predrill assembly for forming a predrilled hole and a plug hole within the designated substrate, the predrill assembly having a first set of parameters;

an insert for insertion into the predrilled hole formed by the precisely matched predrill assembly, the insert having a second set of parameters for the designated substrate predetermined to precisely match the first set of parameters of the predrill assembly to enable the insert to be precisely seated within the predrilled hole; and

a plug for insertion into the plug hole formed by the precisely matched predrill assembly, the plug having a third set of parameters for the designated substrate predetermined to precisely match the first set of parameters of the predrill assembly to enable the plug to be precisely seated within the plug hole.

In another aspect of the present invention, there is provided a system for precisely matching an insert to a predrilled hole and a plug to a plug hole within a designated substrate comprising:

an insert having a first set of parameters;

a plug having a second set of parameters; and

an information source containing information enabling the user to locate a predrill assembly having a third set of parameters forming a precise match with the first and second sets of parameters of the insert and plug, respectively, for the designated substrate to enable the insert to be precisely seated within the predrilled hole and the plug to be precisely seated within the plug hole.

In another aspect of the present invention, there is provided a method for precisely matching a plug to a plug hole corresponding to a predrilled hole in a designated substrate comprising:

forming a predrilled hole and a plug hole in the designated substrate from a predrill assembly having a first set of parameters;

inserting an insert having a second set of parameters precisely matched with the first set of parameters of the predrill assembly for the designated substrate into the predrilled hole to precisely seat the insert within the predrilled hole; and

inserting a plug having a third set of parameters precisely matched with the first set of parameters of the predrill assembly for the designated substrate into the plug hole to precisely seat the plug within the plug hole.

### BRIEF DESCRIPTION OF THE DRAWINGS

The following drawings are submitted for illustrative purposes only and are not intended to limit the invention as encompassed by the claims forming part of the application.

FIG. 1A is a side view of an embodiment of a predrill assembly for use in forming a predrilled hole to seat a matching insert;

FIG. 1B is a cross-sectional view of the predrill assembly of FIG. 1A.

FIG. 2 is a side view of an embodiment of a predrill assembly for use in the present invention;

FIG. 3 is a front view of an embodiment of an insert in the form of a countersink screw which can be precisely matched with a predrill assembly;

FIG. 4 is a side elevational view of another embodiment of a predrill assembly for use in the present invention;

FIG. 5 is a chart for demonstrating the precise matching of predrill assemblies, inserts and plugs for fastening a designated substrate;

FIG. 6 is a perspective view of a plug for insertion into a hole or recess of a substrate for one embodiment of the present invention;

FIG. 7A is a cross sectional view of a plug inserted into a hole concealing an insert for one embodiment of the present invention;

FIG. 7B is a cross sectional view of a plug inserted into a hole concealing an insert for another embodiment of the present invention;

FIG. 7C is a cross sectional view of a plug inserted into a hole concealing an insert for another embodiment of the present invention; and

FIG. 7D is a cross sectional view of a plug inserted into a hole concealing an insert for another embodiment of the present invention.

### DETAILED DESCRIPTION OF THE INVENTION

As previously indicated, there are several factors which go into constructing a predrill assembly for predrilling a predrilled hole and a plug hole in a particular type of substrate (e.g., decking material, flooring material, furniture material) and for matching an insert (e.g. countersink screw) and a plug so that there is optimum fit of the insert within the predrilled hole, and the plug within the plug hole. Previously, consumers were often left to their own devices to try to match predrill assemblies with inserts and plugs although some guidance has been provided by the industry. However, there has been no provision for precisely matching predrill assemblies, inserts and plugs for a designated substrate so that the disadvantages associated with prior art approaches are at least substantially reduced if not entirely eliminated.

As used herein the term “designated substrate” shall mean individual, group or class of substrates that share common properties so that a precisely matched predrill assembly, insert and plug will be suitable for performing a fastening operation for the individual, group or class of substrates. The substrate may be selected from any suitable material including, but not limited to, decking material, flooring material, and furniture material.

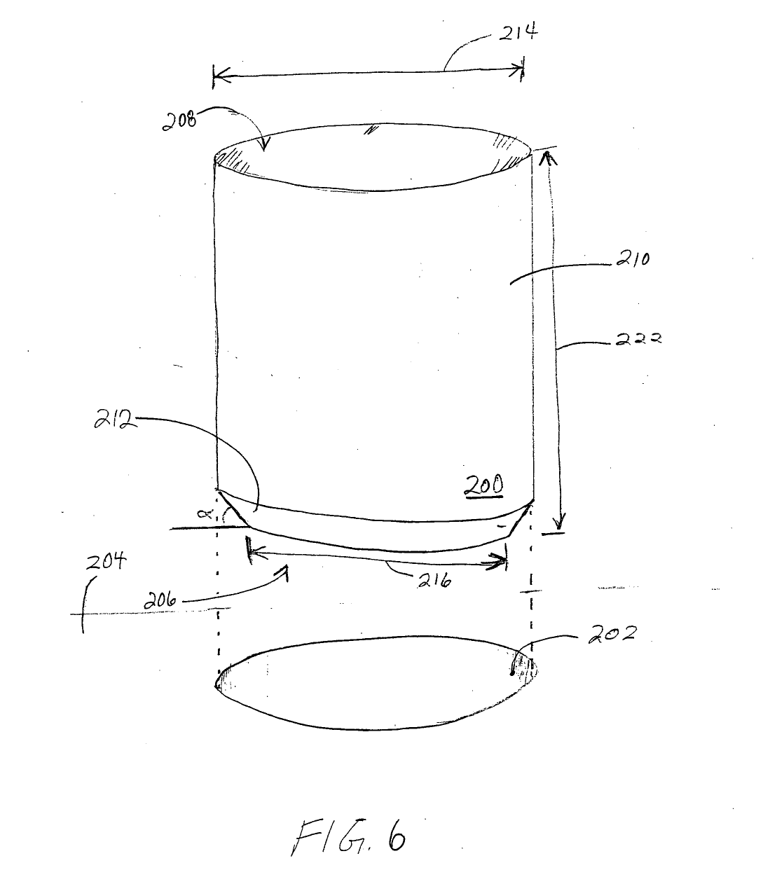

As used herein, the term “plug” refers to a piece of deformable material typically one which is at least substantially cylindrical for tightly sealing a recess or plug hole provided in the substrate. Examples of suitable plugs include straight-walled plugs, and plugs having a lower end chamfered portion (as shown, for example, in FIG. 6). Plugs are often but not always made from the same material as the substrate in order for the plug to blend in with the substrate surface and for functional reasons as previously described.

In accordance with the present invention, the predrill assembly is matched with the insert and plug by taking into account the dimensions and type of material for each and various characteristics of the substrate including its composition. To accomplish this, the type of substrate (e.g. decking material, flooring, furniture surface, etc.), and the type of material of the substrate (e.g. hardwood, composite, etc.) are considered when selecting the predrill assembly and the insert. Once the proper size and material of the insert and plug are known, the dimensions of the predrill assembly which forms the predrilled hole (e.g. predrill bit) and the plug hole in the substrate must be precisely determined and matched so that once the predrilled hole and plug hole are formed, the insert is precisely positioned within the predrilled hole with respect to depth, diameter and head configuration, especially when the insert is a countersink screw, and the plug is precisely positioned within the plug hole with respect to length, major diameter, minor diameter, angle of incline and composition of plug material, and the requirements, if any, for space in the hole for adhesive and adhesive dispersal.

The predrill assembly, the inserts and the plugs can be sold as a single package (e.g. a kit). The user can determine what kits are suitable for a particular type of substrate and then purchase that kit which includes both the predrill assembly, inserts and the plugs. In an alternative embodiment, one can purchase the predrill assembly or the inserts or the plugs separately and then match the purchased component (e.g. insert or plug) with the other component (e.g. predrill assembly) by resorting to information appearing on a card or other information providing device at the point of purchase, on the internet or through other product literature such as installation guidelines. Where the use of an adhesive is advisable, the kit or installation guidelines may also include the adhesive and an adhesive dispenser designed to deliver the correct amount of the correct adhesive into precisely the correct place, either into the plug hole or onto the plug itself before insertion.

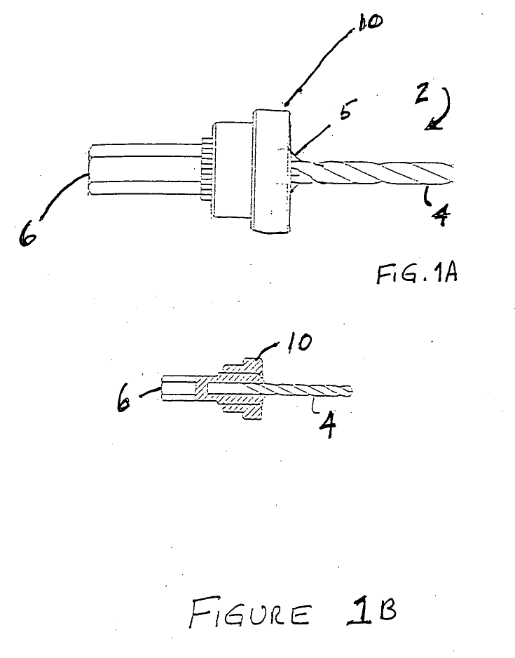

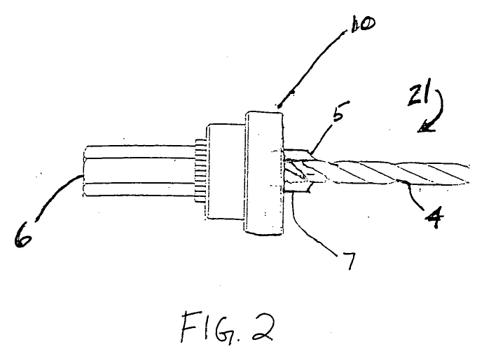

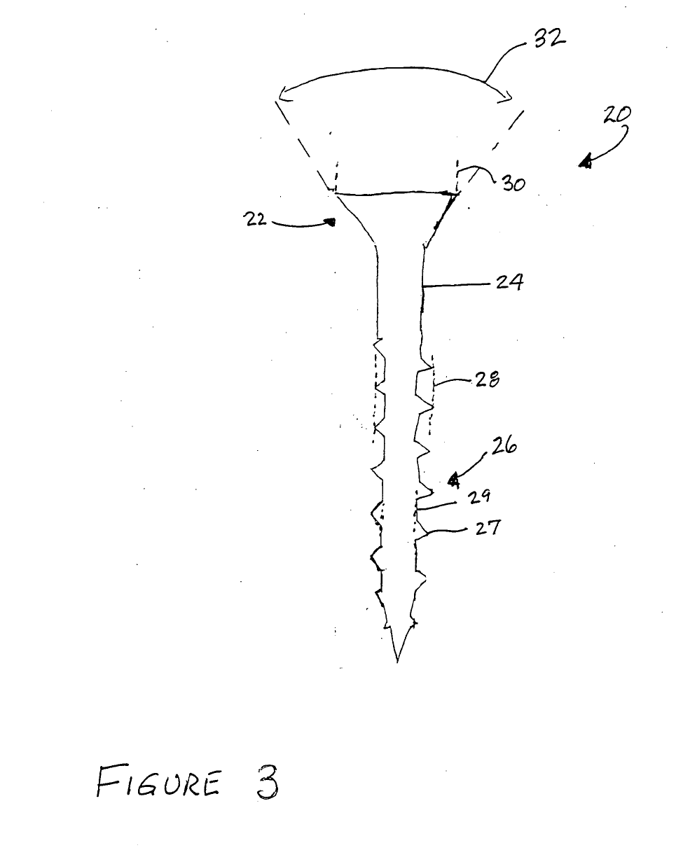

Referring to the drawings and particularly to FIGS. 1A and 1B, a standard predrill assembly 2 includes a predrill bit 4 having countersink cutting edges 5 and an opposed interlocking portion 6 which is adapted to be inserted into a predrill tool or other boring tool (not shown). The predrill assembly may have a stop collar 10 to assist in limiting the depth of the predrilled hole to a precisely desired dimension. The predrilling tool assembly of the type shown in FIGS. 1A and 1B will be precisely matched with an insert (e.g. countersink screw) of the type shown in FIG. 2 taking into account the designated substrate. Once the predrill assembly is used to form a predrilled hole in the substrate, the matching insert will be precisely seated therein, respectively.

Referring to FIG. 2, a predrill assembly 21 is shown for one embodiment of the present invention. The predrill assembly 21 is similar to the predrill assembly 2 of the previous embodiment. The predrill assembly 21 further includes cutting edges 7 located proximately to the countersink cutting edges 5 and adapted to form a plug hole. The cutting edges 7 are suitably dimensioned to produce a plug hole for receiving and accommodating a plug that conceals or covers the matching insert precisely seated within the predrilled hole.

The stop collar 10 assists in limiting the depth of the predrilled hole and the plug hole to precisely desired dimensions. The predrill assembly 21 is precisely matched with an insert of the type shown in FIG. 3 taking into account the designated substrate as described in connection with the predrill assembly 2. The predrill assembly 21 is further matched with a plug having a straight-walled configuration (i.e., cylindrical plug) or one having a lower end chamfered portion such as a plug of the type shown in FIG. 6. Once the predrill assembly 21 is used to form a predrilled hole and a plug hole in the substrate, the matching insert and the plug will be precisely seated therein, respectively. It is understood that the system of the present invention is not limited to a particular type of plug and may be adapted to utilize straight-walled or cylindrical plugs and plugs having a lower end chamfered portion as well as others.

As previously indicated, there are several factors, which are relevant to the precise matching of an insert to a predrill assembly. With respect to the insert, the relevant factors include strength, hardness, length, the major diameter, the minor diameter, the diameter of the unthreaded shank portion, composition of insert material, the type of threads and the head design including the insert head diameter and the degree of countersink (i.e. the angle of the insert head). With respect to the plug, the relevant factors include length, major diameter, minor diameter, composition of plug material, the orientation of the grain (if wood) and the need, if any, for adhesive.

With respect to the predrill assembly, factors which are relevant to achieving a precise match with the insert, include, strength, hardness, length, diameter, composition, and the predrill head design including head diameter, the degree of countersink and the depth of the countersink.

Referring to FIG. 3, there is shown an insert 20 in the form of a countersink screw. The insert 20 is comprised of a head portion 22, an unthreaded portion 24 and a threaded portion 26 including threads 27. The threads 27 are provided with a major diameter 28 extending from the outer edge of one helical thread turn to an opposed outer edge, and a minor diameter 29 measured between opposed valleys formed between adjacent threads 27.

The head portion 22 has a diameter 30 and a countersink angle identified by the numeral 32, respectively. Each of the factors identified above for the insert are selected in order to arrive at an insert precisely matched to a predrill tool so that the insert will precisely fit into the predrilled hole created by the precisely matched predrill assembly, taking into account a designated substrate.

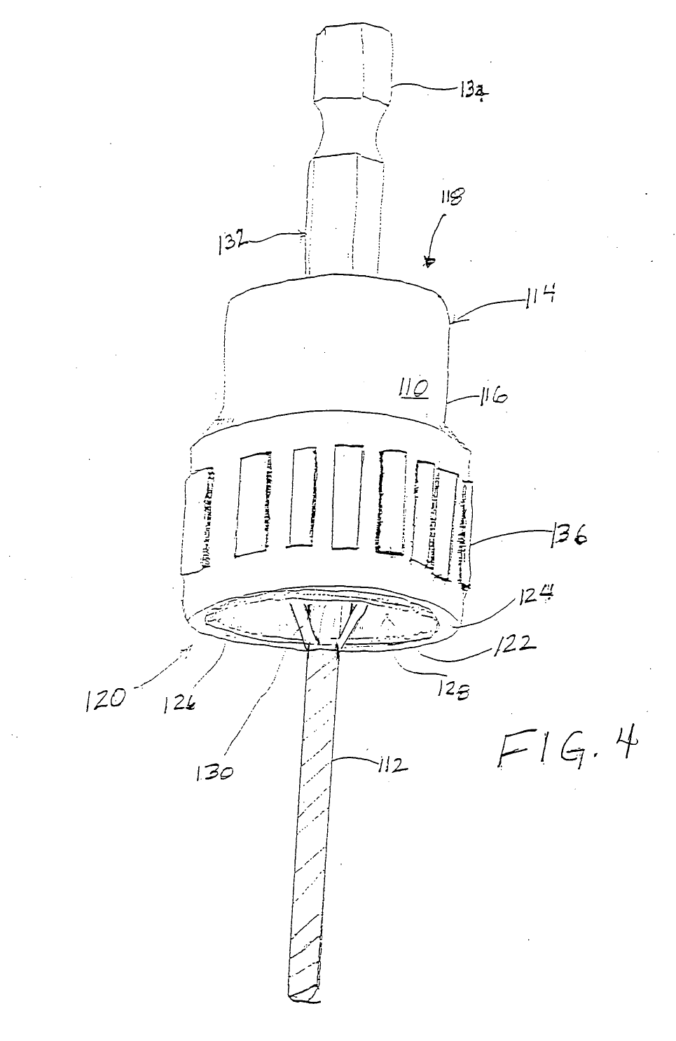

In another embodiment of the invention, the predrill assembly is of the type disclosed in Applicant's U.S. Pat. No. 7,258,513, which is shown in FIG. 4 herein. The predrill assembly can be readily adapted to form a predrilled hole 218 and a plug hole 202 arrangement as shown in FIGS. 6A-6D, for example.

With reference to FIG. 4 herein, there is shown a predrill assembly identified generally by the reference numeral 110 with a predrilled hole forming device in the form of a predrill bit 112 attached thereto. The predrill assembly 110 is useful for implementation with various predrill hole forming tools including predrilling and boring tools as, for example, electric hand-holdable drills, and drill presses. The predrill bit may be selected from any suitable predrill bits including, but not limited to, twist drill bits, spade drill bits, brad point drill bits, countersink drill bits, hole saw bits, Forstner bits, masonry bits, and corner bits. The predrill bit shown in the drawings and particularly FIG. 4 is a countersink predrill bit having countersink cutting edges 130 for forming a countersink hole. The countersink cutting edges 130 can be further adapted to form a plug hole disposed above the countersink hole (see FIG. 2). The predrill bit 112 may be permanently attached to the predrill assembly via a suitable fastener mechanism as known in the art. The predrill bit may be removably fastened to the predrill tool assembly through a predrill bit replacement assembly to allow replacement of worn or damaged predrill bits.

The predrill assembly 110 shown specifically in FIG. 4 includes a stop collar 114 having a substantially cylindrical shell 16 in the form of an inverted cup with a closed-proximal end portion 118 and an open distal end portion 120, and a spindle 132 extending axially through the closed proximal end portion 118 of the stop collar 114. The spindle 132 is securely connected to a predrill tool (not shown), such as a drilling machine or auger, via a connector portion 134. The connector portion may be inserted into a gripping device, such as a cullet grip or chuck. The spindle 132 is structurally coupled to the predrill bit 112 at the end opposite from the connector portion 134, and thus transmits rotational power from the predrill tool to the predrill bit 112. The stop collar 114 is adapted to rotate independently from the spindle 132 and the predrill bit 112 as will be further described hereinafter.

The stop collar 114 includes an opening 122 and a workpiece engaging portion 124 extending along the periphery of the opening 122 at the bottom end portion 120. The workpiece engaging portion 124 of the stop collar 114 is adapted to contact the surface of a workpiece during the drilling operation. Because the stop collar 114 rotates essentially independently of the spindle 132 (and predrill bit 112), it will cease rotating upon minimal driving frictional contact with the workpiece and therefore at least substantially avoids marring of the workpiece. As used herein the term “minimal driving frictional contact” shall mean the minimal force or resistance necessary to completely stop rotation of the stop collar while avoiding marring of the workpiece.

It is preferred that the workpiece engaging portion 124 of the stop collar 114 be composed of a material exhibiting a low coefficient of friction such as Teflon or nylon to further minimize the possibility of marring or other damage to the workpiece, while generating sufficient friction to overcome the momentum of the stop collar 114 and cause it to stop rotating upon contact. The stop collar 114 may further include a stop ring 126 composed of a resilient material such as rubber. The stop ring 126 extends along and forms part of the workpiece engaging portion 124 and is the part of the workpiece engaging portion 124 that comes directly in contact with the workpiece. The stop ring 126 provides a cushioning and gripping effect during contact with the workpiece and therefore facilitates the immediate stoppage of rotation of the stop collar 114 with the workpiece.

The cylindrical shell 116 is preferably constructed of a hard but lightweight material typically a plastic or metal, such as a Teflon-polycarbonate blend or nylon. As noted above, the workpiece engaging portion 124 of the shell 116 is preferably composed of a material having a low coefficient of friction, preferably in the range of 0.04 to 0.10, such as nylon, but may also be formed from a teflon polycarbonate blend or any other suitable material.

In the embodiment of FIG. 4, the stop collar 114 comprises a cavity 128 defined by the interior of the cylindrical shell 116 which is in communication with the opening 122. During predrilling, debris generated by the interaction of the predrill bit and the workpiece is effectively initially collected and then compacted as more debris accumulates in the cavity 128. The compacted debris forms an agglomerated mass, which may be subsequently removed by the user.

The compacted debris in the cavity 128 may be released by rotating the predrill bit while holding the stop collar 114 to prevent rotation thereof. The turbulence created within the cavity by rotation of the predrill bit 112 is usually sufficient to dislodge the compacted debris. Alternatively, the operator may insert a predrill hole forming device such as a screw or other pointed object into the cavity to dislodge the debris. Accordingly, the stop collar 114 effectively prevents debris from dropping onto the surface of the workpiece, which could result in imprecise drilling depth and/or inadvertent marring or other damage to the workpiece.

The size of the cavity 128 can vary. However, the cavity must be sufficiently large to enable the debris to be collected therein, yet small enough to enable the collected debris to be compacted therein as an agglomerated mass during the hole forming operation.

The cavity is preferably sufficiently large so that debris from at least twenty predrilled holes and plug holes can be collected and compacted before it is necessary to remove the debris. The size of the cavity may be selected depending on a variety of factors including the type of debris including shape and density, the dimensions of the hole and the plug hole (and therefore the amount of debris per hole) and the like. By way of example and for illustrative purposes only, a depth limiting device for predrilling using a #10 countersink screw having a countersink bore depth of about 13 mm and a predrill bit length measured from the end of the countersink of about 27 mm would employ a stop collar having a cavity with a depth of about 15.6 mm, an inside diameter of about 20 mm and an inside spacing between the countersink bore and the inside cavity wall of about 5.25 mm.

A plurality of ridges 136 may be applied to the exterior portion of the cylindrical shell 16 of the stop collar 114 to provide the user with a gripping surface to stop the stop collar 14 from rotating during drilling. Independently from providing a gripping surface, the ridges 136 can also provide a visual means of determining precisely when the stop collar 114 stops rotating. When the stop collar rotates during the drilling operation, the ridges 36 become blurred to the naked eye (i.e. the individual ridges are not readily discernible) depending on the speed of rotation. When the stop collar 114 engages the workpiece at the minimal driving frictional contact, the stop collar stops rotating and the ridges are no longer blurred but are readily discernible. The observance of the individual ridges 136 is therefore an immediate indication that the stop collar 114 has stopped rotating and the hole has reached the desired depth in the workpiece.

In addition to or as an alternative, all or part of the outside surface of the stop collar 114 can be made more visible to the naked eye such as by using a different color, especially a bright color than the rest of the stop collar. The presence of a more distinct color on the stop collar can also facilitate observance of the precise moment that the stop collar ceases rotation when it achieves minimal driving frictional contact with the workpiece.

Once again, the predrill assembly and the inserts are matched according to the criteria previously described taking into account the characteristics of the designated substrate to provide the user with the ability to provide a precisely seated insert and plug in the substrate.

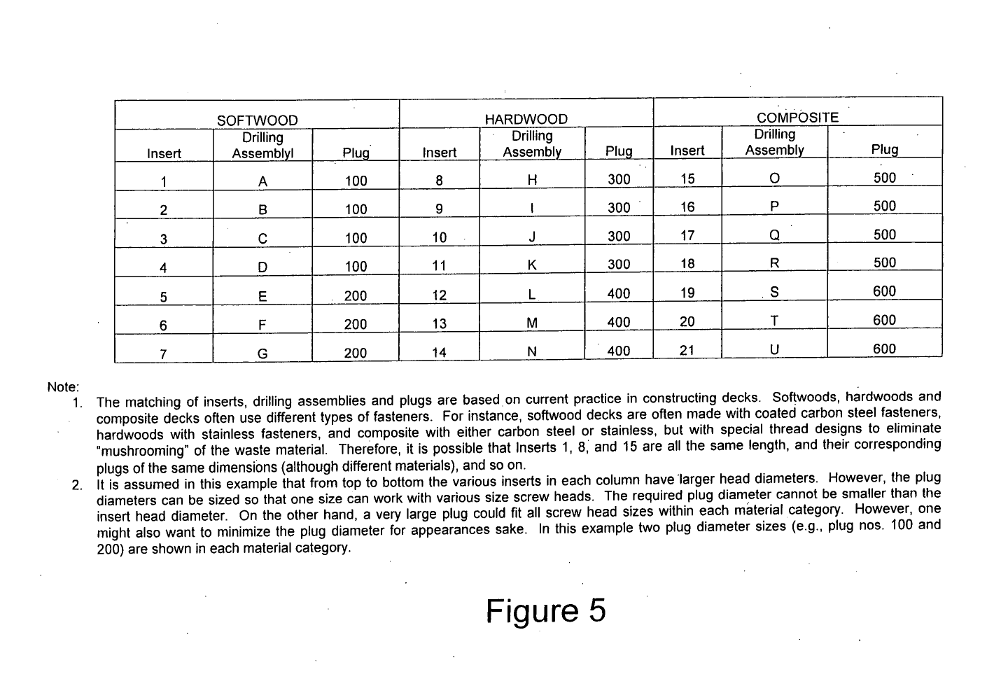

Referring to FIG. 5, there is shown a card or other information providing device which can be used by the consumer at the point of retail to purchase either an insert, a plug or a predrill assembly and then to precisely match the other component(s) to the one that is purchased. The use of the card provides flexibility to enable the individual components to be sold separately instead of being sold together as a prepackaged kit. As shown in FIG. 5, the insert is identified by a number (e.g. No. 1).

Each insert will have at least one dimension that differs from each other insert. In the Example shown in FIG. 5, there are twenty-one different inserts. However, the present system embraces more or less different inserts than exemplified in FIG. 5. The predrill assembly precisely matched to each insert 1-21 is identified by a letter (e.g. A, B or C). One factor in matching inserts and predrill assemblies is the composition of the selected substrate (e.g. softwood).

The same card method may also be utilized for plugs. As shown in FIG. 5, six different plugs are provided each identified by the arbitrary number 100, 200, etc. Typically the same plug may be used for different insert-drill assembly matches. For example plug 100 is suitable for matching inserts 1-4 and drill assemblies A-D providing, as indicated in Note 2 that the plug diameter cannot be smaller than the insert head diameter. It will also be understood that other variables including plug characteristics may be illustrated on the card as well.

By way of example and referring to FIG. 5, an insert designated by the numeral 1 may be matched with a predrill assembly designated by the letter “A” which makes a relatively small hole for a relatively thin softwood substrate (e.g. yellow pine). A predrill assembly designated by the letter “B” makes a relatively larger hole for insert 2 which is longer and heavier in gauge than insert 1. This application is for a thicker size of softwood substrate than the previous example, thus requiring a larger insert. A predrill assembly “C” makes an even larger hole for a still thicker softwood substrate to accommodate a still larger insert 3. In each case a plug #100, made from the same softwood substrate and having a plug diameter that cannot be smaller than the insert head diameter, can be used to fill the plug hole.

Referring to FIG. 6, there is shown a plug 200 plug having a lower end chamfered portion adapted for insertion into a plug hole 202 extending into a substrate or workpiece 204 (e.g. wood) for one embodiment of the present invention. The plug 200 comprises a first end 206 for insertion into the plug hole 202 and a second end 208 opposite thereto, a substantially cylindrical side portion 210 extending vertically between the first and second ends 206 and 208, a chamfer edge portion 212 proximate to the side portion 210, extending along the outer periphery of the first end 206. The second end 208 and the side portion 210 are provided with a major diameter 214 extending from one side to the opposite side thereof, a minor diameter 216 measured across the first end 206 of the plug 200, a length or depth 222 measured vertically along the side portion 210, and an angle of incline identified by α, measuring the incline of the chamfer edge portion 212 relative to horizontal. Generally, the straight-walled or cylindrical plugs comprise the same major and minor diameters, while plugs with a lower end chamfered portion have a minor diameter less than the major diameter. The diameter of the plug hole 202 is preferably matched as closely as possible to the major diameter 214 of the plug 200 to provide a tight tolerance.

Each of the factors identified above for the plug 200 are selected in order to arrive at a plug 200 precisely matched to a predrill tool so that the plug 200 will precisely fit into the plug hole 202 created by the precisely matched predrill assembly, taking into account a designated substrate, so that zero to minimal finishing is needed. An example of minimal finishing is light sanding

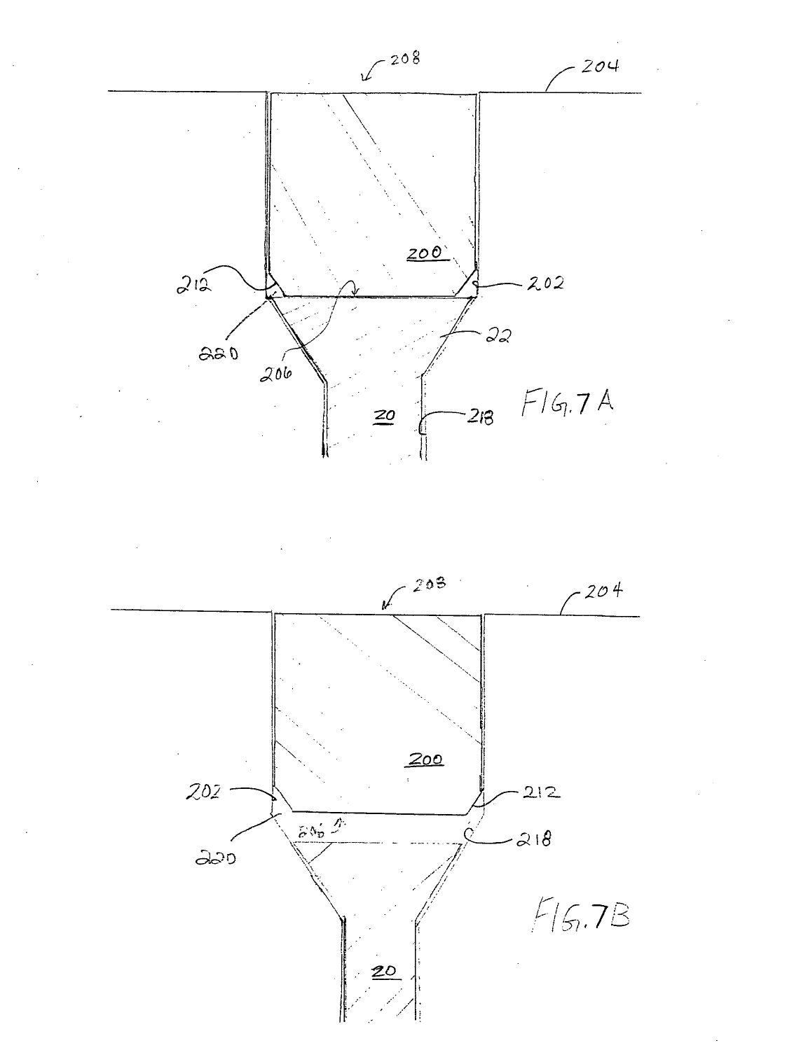

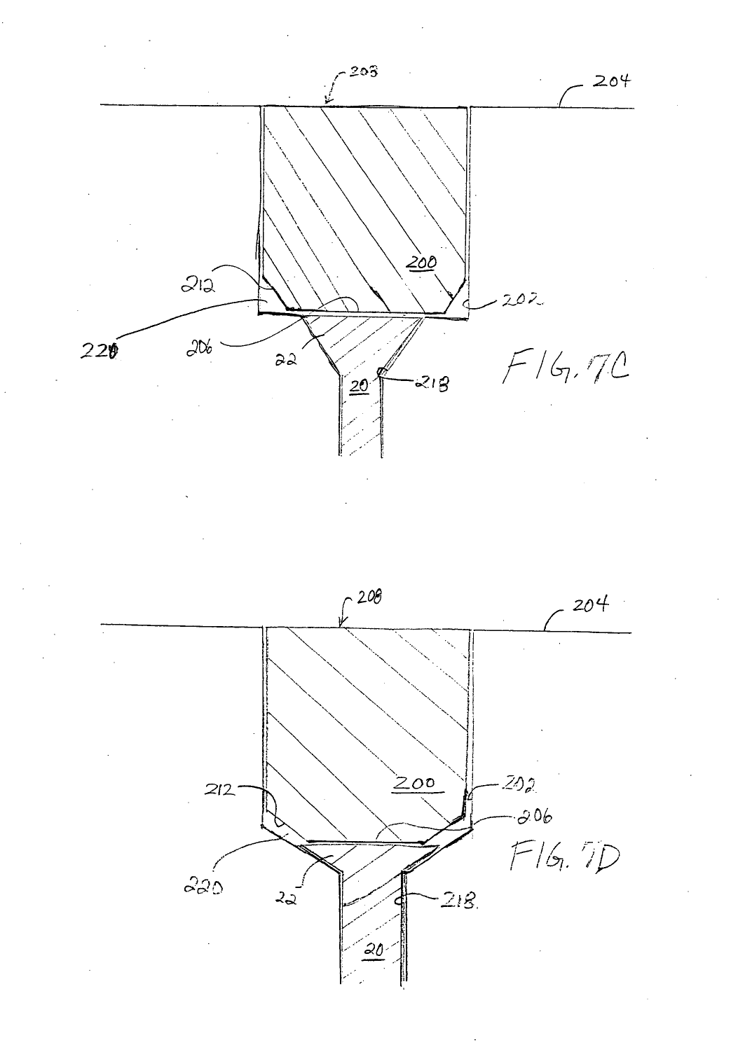

Referring to FIGS. 7A-7D, various arrangements may be used for seating the insert 20 in the predrilled hole 218 and the plug 200 in the plug hole 202 as shown. In each of the examples shown, the diameter of the insert head portion 22, length or depth of the plug 200, and sizes and profiles of the plug hole 202 and predrilled hole 218 may be varied to arrive at the illustrated configurations. The plug 200 is disposed securely within the plug hole 202 above the predrilled hole 218 to effectively conceal the inert 20 from the exterior. The chamfer edge portion 212 of the plug 200 in combination with the walls of the plug hole 202, define a chamfer space 220. The chamfer space 220 provides a gathering area for an adhesive applied to the plug hole 202 as the plug 200 is inserted. This greatly minimizes the leakage of the adhesive through the gap between the walls of the plug hole 202 and the plug 200 and permits thermal expansion of the materials to reduce stresses that can lead to dislodgement of the plug 200 over time.

### EXAMPLE 1

A precisely matched predrill assembly and insert was developed for a fastening operation in which a designated substrate for use as a decking material was comprised of a ¾″ thick top portion made out of a high density tropical hardwood (e.g. ipe) or medium density tropical hardwood (e.g. mahogany) and a subsurface of a softwood (e.g. yellow pine). The desired result of this example is to have a screw head mounted flush with the upper surface of the top portion of the decking material.

An insert was selected with the following characteristics for this application. The insert was a countersink screw of the type shown in FIG. 3 with a screw size 10×2½ (a screw having a length measured from the top surface of the head portion to the opposed end of 63.5 mm (2½ inches), a major diameter of 5.2 mm, a minor diameter of 3.2 mm, a threaded portion length of 44.5 mm (1¾ inches), a countersink angle of 90° and a head diameter of 9.2 mm) made of a stainless steel. The desired insert was precisely matched with a predrill assembly of the type shown in FIG. 4 in which the overall length of the predrill bit was ¾ inch, the diameter of the predrill bit was 3.8 mm, the countersink angle was 90°, and the width of the countersink head was 9.2 mm. The predrill assembly was manufactured to precisely fit the dimensions of the insert to provide a predrill hole of ¾″ depth (passing through the hardwood portion but not the softwood portion) capable of precisely seating the insert therein. The predrill bit was made of cobalt steel, which is desired for drilling through high density tropical hardwoods.

### EXAMPLES 2-6

The process of Example 1 was repeated to provide a precise match between a desired insert and predrill assembly based on the fastening of a designated substrate in the form of a decking material having characteristics shown in Table 1. It will be understood that the same process described above can be applied to plugs for insertion into plug holes produced by the predrill assembly.

TABLE 1

| | | | | | TOOL |
|---|---|---|---|---|---|
| | SURFACE | SUBSURFACE | | | SPECIFICATIONS |
| | MATERIAL | MATERIAL | COUNTER- | SCREW | COUNTERSINK |
| EXAMPLE | (Decking) | (Joists) | SINK DEPTH | SIZE | WIDTH (mm) |
| Ex. 2 | high density | high density | Flush | 10 × 2½″ | 9.20 |
| | hardwood ¾″ | hardwood | | | |
| Ex. 3 | medium density | medium density | Flush | 10 × 2½″ | 9.20 |
| | hardwood ¾″ | hardwood ¾″ | | | |
| Ex. 4 | high density | high density | pocket for ⅜ | 10 × 2½″ | 9.60 |
| | hardwood ¾″ | hardwood ¾″ | inch plug | | |
| Ex. 5 | medium density | Medium density | pocket for ⅜ | 10 × 2½″ | 9.60 |
| | hardwood ¾″ | hardwood ¾″ | inch plug | | |
| Ex. 6 | high or medium | softwood | pocket for ⅜ | 10 × 2½″ | 9.60 |
| | density | | inch plug | | |
| | hardwood ¾″ | | | | |

| | | | | DEPTH OF |
|---|---|---|---|---|
| | | | | COUNTER- |
| | | | OVERALL | SINK |
| | COUNTER- | DRILL BIT | HOLE | BELOW |
| | SINK ANGLE | DIAMETER | DEPTH | SURFACE |
| EXAMPLE | (DEGREES) | (mm) | (INCHES) | (mm) |
| Ex. 2 | 90 | 3.6 | 2½ | flush |
| Ex. 3 | 90 | 3.2 | 2½ | flush |
| Ex. 4 | 90 | 3.6 | 2¾ | 6.25 |
| Ex. 5 | 90 | 3.2 | 2¾ | 6.25 |
| Ex. 6 | 90 | 3.6 | 1 | 6.25 |

Notes:
1. ⅜″ plugs: The ⅜ inch measure refers to the diameter measured at the top (measure #214 on Fig. 6). These plugs generally, and in this example are, ¼ inch in height (measure #222 on Fig. 6). In metric terms, ⅜″ × ¼″ is 9.53 mm × 6.35 mm. This is the nominal size of the plugs used in this example. In reality, since these plugs are generally made from wood, on this example there is an assumed minus/plus variation in both width and height measures of (−).05 mm-(+).05 mm.
2. Countersink width. In Examples 2 and 3 the countersink width corresponds to the width of the screw head diameter (measure #30 on Fig. 3). Examples 4, 5, and 6 utilize a ⅜″ plug with a greater diameter than the 10 gauge screw. The width of the hole must be sufficiently large to accommodate the largest size plug diameter, which given the assumed minus/plus manufacturing tolerance, is 9.60 (actually 9.58, but in reality it would be rounded to 9.60 in tool manufacture). Any gapping would be made up by the use of adhesive. Alternatively, and preferably, the plugs could be made to much tighter tolerances, and the difference between the hole diameter and plug diameter could be reduced or even eliminated.
3. Depth of countersink: If the ¼″ deep hole were slightly undersized by .05 mm, it would have a height at the low range of 6.30 mm. In this example it is assumed that some slight sanding would be done in any case to remove excess glue and give a better blended appearance. Since there will be some sanding, this example uses a depth of 6.25 mm for the plug portion of the hole. That way, and given the assumed plus/minus manufacturing tolerances, a plug of 6.30-6.40 in height will always come slightly above the surface, which can be eliminated by minor sanding. In other examples, the plug height and hole depth can be precisely matched so no further sanding or refinishing would be needed.

What is claimed is:

1. A system for precisely matching a plug to a plug hole corresponding to a predrilled hole within a designated substrate comprising:
a predrill assembly for forming a predrilled hole and a plug hole within the designated substrate, said predrill assembly having a first set of parameters;
an insert for insertion into the predrilled hole formed by the precisely matched predrill assembly, said insert having a second set of parameters for the designated substrate predetermined to precisely match the first set of parameters of the predrill assembly to enable the insert to be precisely seated within the predrilled hole; and
a plug for insertion into the plug hole formed by the precisely matched predrill assembly, said plug having a third set of parameters for the designated substrate predetermined to precisely match the first set of parameters of the predrill assembly to enable the plug to be precisely seated within the plug hole.

2. The system of claim 1, wherein the plug is selected from the group consisting of a straight-walled or cylindrical plug and a plug having a lower end chamfered portion.

3. The system of claim 2 wherein the plug having a lower end chamfered portion further comprises:
a first end for insertion into the plug hole and a second end opposite thereto;
a substantially cylindrical side portion extending vertically between the first and second ends; and
a chamfer edge portion proximate to the side portion, extending along the outer periphery of the first end.

4. The system of claim 1 wherein the third set of parameters for the plug is selected from the group consisting of length, major diameter, minor diameter, angle of incline, and composition of plug material.

5. The system of claim 1 wherein the predrill assembly comprises a depth limiting device having a stop collar, a spindle and means operatively associated with the stop collar and the spindle for isolating the rotation of the spindle from the stop collar.

6. The system of claim 1 wherein the insert is a countersink screw.

7. The system of claim 1 wherein the second set of parameters for the insert is selected from the group consisting of length, major diameter, minor diameter, diameter of unthreaded portion, strength, hardness, composition of insert material, type of threads, and head design.

8. The system of claim 7 wherein the insert is a countersink screw and the head design includes the width of the head and countersink angle.

9. The system of claim 1 wherein the first set of parameters for the predrill assembly is selected from the group consisting of strength, hardness, length, diameter, composition, and predrill head design.

10. The system of claim 9 wherein the predrill head design includes head diameter, degree of countersink, depth of countersink, and plug hole diameter and depth.

11. The system of claim 1 wherein the designated substrate is selected from the group consisting of decking material, flooring material, and furniture material.

12. A system for precisely matching a plug to a plug hole within a designated substrate comprising:
a predrill assembly for forming a predrilled hole and a plug hole within the designated substrate, said predrill assembly having a first set of parameters;
an information source containing information enabling the user to locate an insert for insertion into the predrilled hole, said insert having a second set of parameters predetermined to match precisely the first set of parameters of the predrill assembly for the designated substrate to enable the insert to be precisely seated within the predrilled hole; and
an information source containing information enabling the user to locate an plug for insertion into the plug hole, said plug having a third set of parameters predetermined to match precisely the first set of parameters of the predrill assembly for the designated substrate to enable the plug to be precisely seated within the plug hole.

13. The system of claim 12 wherein the plug is selected from the group consisting of a straight-walled or cylindrical plug and a plug having a lower end chamfered portion.

14. The system of claim 13 wherein the plug having a lower end chamfered portion, further comprises:
a first end for insertion into the plug hole and a second end opposite thereto;
a substantially cylindrical side portion extending vertically between the first and second ends; and
a chamfer edge portion proximate to the side portion, extending along the outer periphery of the first end.

15. The system of claim 12 wherein the third set of parameters for the plug is selected from the group consisting of length, major diameter, minor diameter, angle of incline, and composition of plug material.

16. The system of claim 12 wherein the predrill assembly comprises a depth limiting device having a stop collar, a spindle and means operatively associated with the stop collar and the spindle for isolating the rotation of the spindle from the stop collar.

17. The system of claim 12 wherein the insert is a countersink screw.

18. The system of claim 12 wherein the second set of parameters for the insert is selected from the group consisting of length, major diameter, minor diameter, diameter of unthreaded portion, strength, hardness, composition of insert material, type of threads, and head design.

19. The system of claim 16 wherein the insert is a countersink screw and the head design includes the width of the head and countersink angle.

20. The system of claim 12 wherein the first set of parameters for the predrill assembly is selected from the group consisting of strength, hardness, length, diameter, composition, and predrill head design.

21. The system of claim 20 wherein the predrill head design includes head diameter, degree of countersink and depth of countersink.

22. The system of claim 12 wherein the designated substrate is selected from the group consisting of decking material, flooring material, and furniture material.

23. A system for precisely matching an insert to a predrilled hole and a plug to a plug hole within a designated substrate comprising:
an insert having a first set of parameters;
a plug having a second set of parameters; and
an information source containing information enabling the user to locate a predrill assembly having a third set of parameters forming a precise match with the first and second sets of parameters of the insert and plug, respectively, for the designated substrate to enable the insert to be precisely seated within the predrilled hole and the plug to be precisely seated within the plug hole.

24. The system of claim 23 wherein the plug is selected from the group consisting of a straight-walled or cylindrical plug and a plug having a lower end chamfered portion.

25. The system of claim 23 wherein the plug having a lower end chamfered portion, further comprises:
a first end for insertion into the plug hole and a second end opposite thereto;
a substantially cylindrical side portion extending vertically between the first and second ends; and
a chamfer edge portion proximate to the side portion, extending along the outer periphery of the first end.

26. The system of claim 23 wherein the second set of parameters for the plug is selected from the group consisting of length, major diameter, minor diameter, angle of incline, and composition of plug material.

27. The system of claim 23 wherein the predrill assembly comprises a depth limiting device having a stop collar, a spindle and means operatively associated with the stop collar and the spindle for isolating the rotation of the spindle from the stop collar.

28. The system of claim 23 wherein the insert is a countersink screw.

29. The system of claim 23 wherein the first set of parameters for the insert is selected from the group consisting of length, major diameter, minor diameter, diameter of unthreaded portion, strength, hardness, composition of insert material, type of threads, and head design.

30. The system of claim 29 wherein the insert is a countersink screw and the head design includes the width of the head and countersink angle.

31. The system of claim 23 wherein the third set of parameters for the predrill assembly is selected from the group consisting of strength, hardness, length, diameter, composition, and predrill head design.

32. The system of claim 31 wherein the predrill head design includes head diameter, degree of countersink and depth of countersink.

33. The system of claim 31 wherein the predrill head design includes plug diameter and depth of plug hole.

34. The system of claim 23 wherein the designated substrate is selected from the group consisting of decking material, flooring material, and furniture material.

35. A method for precisely matching a plug to a plug hole corresponding to a predrilled hole in a designated substrate comprising:
forming a predrilled hole and a plug hole in the designated substrate from a predrill assembly having a first set of parameters;
inserting an insert having a second set of parameters precisely matched with the first set of parameters of the predrill assembly for the designated substrate into the predrilled hole to precisely seat the insert within the predrilled hole; and
inserting a plug having a third set of parameters precisely matched with the first set of parameters of the predrill assembly for the designated substrate into the plug hole to precisely seat the plug within the plug hole.

36. The method of claim 35 wherein the plug is selected from the group consisting of a straight-walled or cylindrical plug and a plug having a lower end chamfered portion.

37. The method of claim 36 wherein the plug having a lower end chamfered portion, further comprises:
a first end for insertion into the plug hole and a second end opposite thereto;
a substantially cylindrical side portion extending vertically between the first and second ends; and
a chamfer edge portion proximate to the side portion, extending along the outer periphery of the first end.

38. A predrill assembly for generating a predrilled hole and a plug hole into a designated substrate, comprising:
a stop collar comprising a shell having an open end portion and a substrate engagement portion extending along the open end portion thereof for contacting a substrate;
a spindle extending axially through the shell, the spindle including a first end extending from the exterior of the stop collar for attachment to a hole forming apparatus such as a drilling or boring tool, and an second end interior to the stop collar for attachment to a hole forming bit, wherein the attached bit projects through the open end portion of the stop collar at a predetermined length;
a hole forming bit having a predetermined length projecting through the open end portion of the stop collar, said predetermined length further comprising countersink cutting edges located intermediate between the distal end of the hole forming bit and the open end portion of the stop collar, and plug hole cutting edges located intermediate between the counterside cutting edges and the open end portion of the stop collar;
means operatively associated with the stop collar and the spindle for isolating the rotation of the spindle from the stop collar whereby the stop collar ceases to rotate when contacting the substrate without generating sufficient frictional contact to mar or otherwise damage the substrate.
